(19) United States
(12) Patent Application Publication
(10) Pub. No.: US 2024/0420856 A1
(43) Pub. Date: Dec. 19, 2024

(54) REACTOR CORE SYSTEM

(71) Applicants: Purdue Research Foundation, West Lafayette, IN (US); UT-Battelle, LLC, Oak Ridge, TN (US)

(72) Inventors: Hitesh Bindra, West Lafayette, IN (US); John Matulis, West Lafayette, IN (US); Broderick Sieh, West Lafayette, IN (US); Nathan David See, Knoxville, TN (US); Prashant K. Jain, Knoxville, TN (US)

(73) Assignees: Purdue Research Foundation, West Lafayette, IN (US); UT-Battelle, LLC, Oak Ridge, TN (US)

(21) Appl. No.: 18/672,891

(22) Filed: May 23, 2024

Related U.S. Application Data
(60) Provisional application No. 63/472,668, filed on Jun. 13, 2023.

(51) Int. Cl. G21C 15/253; G21C 5/12; G21C 15/16

(52) U.S. Cl. CPC G21C 15/253; G21C 5/12; G21C 15/16

(57) ABSTRACT

A high-temperature gas-cooled reactor (HTGR) core is disclosed which includes a plurality of nuclear fuel kernels encapsulated by i) solid structures; and ii) porous structures, wherein the solid structures and the porous structures form a heterogeneous tileable repeating assembly including a channel for moving heat out of the HTGR core, wherein a ratio of in-channel porosity to in-channel tortuosity of the assembly is between about 0.2 to about 0.5, wherein the in-channel tortuosity is between about 1.0 and 1.6, and wherein total solid fraction of the assembly is between about 0.6 to about 0.85.

### CROSS-REFERENCE TO RELATED APPLICATIONS

The present non-provisional patent application is related to and claims the priority benefit of U.S. Provisional Patent Application Ser. 63/472,668, filed Jun. 13, 2023, the contents of which are hereby incorporated by reference in its entirety into the present disclosure.

### STATEMENT REGARDING GOVERNMENT FUNDING

This invention was made with government support under DE-NE0009153 and DE-AC05-00OR22725 both awarded by the US Department of Energy. The government has certain rights in the invention.

### TECHNICAL FIELD

The present disclosure is generally related to nuclear reactors and in particular to improving time to onset of natural convection (ONC) during a failure mode of the reactor.

### BACKGROUND

This section introduces aspects that may help facilitate a better understanding of the disclosure. Accordingly, these statements are to be read in this light and are not to be understood as admissions about what is or is not prior art.

Nuclear energy provides nearly 20 percent of America's electricity supply. This percentage is much higher in other countries, e.g., France enjoys 70% of its electricity production from nuclear power. High-temperature gas-cooled reactors (HTGRs) have been a mainstay of electrical power generation in a many countries for many decades. A HTGR is typically a graphite-based reactor, typically utilizing an inert gas, such as He, to cool fuel rods and fissile material, wherein the cooling has can reach temperatures as high as 850° C. to 1000° C. and even higher. Special care must be taken to prevent corrosive gases from having deleterious effect on the structure of the reactor.

Nuclear Energy Agency provides the following background for HTGRs. This design of a HTGR permits a very high outlet temperature in the order of 1000° C. The first HTGR design was proposed at the Clinton Laboratories (now Oak Ridge National Laboratory) in 1947. Germany also played a significant role in HTGR development over the next decade. The Peach Bottom reactor in the United States (US) was the first HTGR to produce electricity, with operation from 1966 through 1974 as a 150 MW (th) demonstration plant. The Fort St. Vrain plant was the first commercial power design, operating from 1979 to 1989 with a power rating of 842 MW (th). Even though the reactor was beset by operational issues that led to its decommissioning due to economic factors, it served as proof of the HTGR concept in the United States. HTGRs have also existed in the United Kingdom (the Dragon reactor) and Germany (AVR and THTR-300), and currently exist in Japan (the HTTR using prismatic fuel with 30 MWth of capacity) and the People's Republic of China (the HTR-10, a pebble bed design with 10 MWe of generation). Two full-scale pebble bed HTGRs, each with 100-195 MWe of electrical production capacity are under construction in China, and are promoted in several countries by reactor designers.

Newer generation-IV reactor designs utilize more recent technologies in both design and operation that improve safety, efficiency, and manufacturability when compared to previous generation designs. A common passive safety feature of generation-IV HTGRs is the ability to dissipate decay heat from the core in many accident situations. In these scenarios the heat removal is expected to be performed by conductive and radiative heat transfer. Therefore it is important to understand passive heat removal for all conceivable modes of failure. In helium cooled HTGRs, after a break in the coolant system, helium leaks out of the reactor. This phenomenon is known as depressurized loss of forced cooling (DLOFC). The highest core temperature anticipated under any circumstance in an HTGR happens during a DLOFC accident. Thus, understanding and mitigation of these accidents can help determine and reduce peak material temperatures and increase safe operating power levels.

Under a DLOFC scenario, air diffuses into the hot moderator-fuel assembly, displacing the inert helium and creating oxidation potential for the hot moderator-fuel assembly. The air ingress phenomenon is expected to be governed by slow molecular diffusion and the system geometry. If the air mass fraction becomes sufficiently high, more rapid air ingress can occur due to the onset of natural convection (ONC). In graphite-moderated HTGRs, when air enters the graphite matrix, graphite oxidation occurs, negatively impacting the passive decay heat removal under non-operating conditions. Similarly, in the case of other new gas-cooled reactor design concepts such as the Transformational Challenge Reactor (TCR), failure mode challenges remain. The TCR program, led by Oak Ridge National Laboratory since 2019, was intended to leverage advances in manufacturing, materials and computation to enable adoption of technologies to facilitate delivery of reliable, low-cost clean nuclear energy. FIG. 1 is a prior art schematic of core vessel and reactor layout, which shows air ingress can cause oxidation and damage the silicon carbide (SiC)-coated core components or interact with the Yittrium Hydride moderator.

Referring to FIG. 1, the core includes fuel assemblies with a central moderator-bearing support structure and fuel elements that are highly packed with conventionally fabricated UN TRi-structural ISOtropic particle fuel (TRISO) particles. Fabrication of both the non-fuel core structural materials and the fuel element matrix is via advanced manufacturing technologies. The core, top and bottom reflectors, and structural members are located within the pressure vessel (FIG. 1). A central channel is reserved for a backup shutdown rod. A control shroud made of a plurality of elements sits outside the pressure vessel and inside the radial reflector.

While there are significant number of safety features, more is needed to guard against coolant leak and failure modes. Referring to FIG. 2, which is a simple schematic of gas flow, the stages of gas flow in a DLOFC accident are depicted. Initially, if the coolant system is above ambient pressure, some helium rushes out of the system (as shown in the window designated as “1”). Next, stratified flow allows the air to fill the lower plenum of the reactor up to the level of the breach (as shown in the window designated as “2”). Then, the air slowly diffuses upwards through the reactor (as shown in the window designated as “3”). The diffusion process can take significant amount of time. Eventually, the air mass fraction reaches a certain point at which ONC occurs (as shown in the window designated as “4”).

The time to ONC is of significant interest. Others have shown how the time to ONC decreases with an increase in temperature. However, porosity of fuel elements plays a significant role.

Therefore, there is an unmet need for a novel approach to improve time to ONC in a reactor failure stemming from fuel element porosity.

### SUMMARY

A high-temperature gas-cooled reactor (HTGR) core is disclosed which includes a plurality of nuclear fuel kernels encapsulated by i) solid structures; and ii) porous structures, wherein the solid structures and the porous structures form a heterogeneous tileable repeating assembly including a channel for moving heat out of the HTGR core, the assembly is both a moderator and a gas coolant channel, wherein a ratio of in-channel porosity of the assembly to in-channel tortuosity of the assembly is between about 0.2 to about 0.5, wherein the in-channel tortuosity is between about 1.0 representing an open channel and 1.6, and wherein total solid fraction of the assembly is between about 0.6 to about 0.85, wherein the in-channel porosity is defined as the ratio between volume of voids in the channel to total volume of the channel including both voids and solid structures inside the channel, in-channel tortuosity is defined as average path length through channel media divided by total channel length, and total solid fraction is defined as total volume of solid structures in the assembly divided by total volume of the assembly.

### BRIEF DESCRIPTION OF FIGURES

FIG. 1 is a schematic of a core vessel and reactor layout, according to the prior art which shows air ingress can cause oxidation and damage the silicon carbide (SiC)-coated core components or interact with the moderator within the core.

FIG. 2 is a simple schematic of gas flow, where stages of gas flow in a depressurized loss of forced cooling accident are depicted.

FIG. 3 is a schematic of domain geometry for simulation showing the monitoring point to help understand onset of natural convection (ONC) during a failure mode of the reactor.

FIG. 4 is a partial perspective view of an isolated Y-channel, according to the present disclosure.

FIG. 5 is a graph of air mass fraction over time for different porosities, where the air mass fraction suddenly jumps to 1.0 after a long, steady increase.

FIG. 6 is a graph of time to ONC vs. porosity for different levels of porosity provided in FIG. 5.

FIG. 7 is a graph of pressure drop vs. porosity.

FIG. 8 is a graph of ONC time vs. pressure drop for various porosities, which shows that there is a diminishing return in ONC time as porosity is decreased.

FIG. 9 is an example honeycomb repeating assembly of solid structures and porous structures, where the assembly is shown to include a plurality of hexagonal structures surrounded by solid structures.

FIG. 10 is a perspective view of the porous material shown in FIG. 9.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel approach is presented herein to improve time to onset of natural convection (ONC) stemming from fuel element porosity during a failure mode of a nuclear reactor. Towards this end, the present disclosure provides simulation results that are built on top of others' simulation, which results provide guidance on how to print fuel elements and reactor parts. The porous geometries being simulated in this work represent complex geometries that can only be made with additive manufacturing.

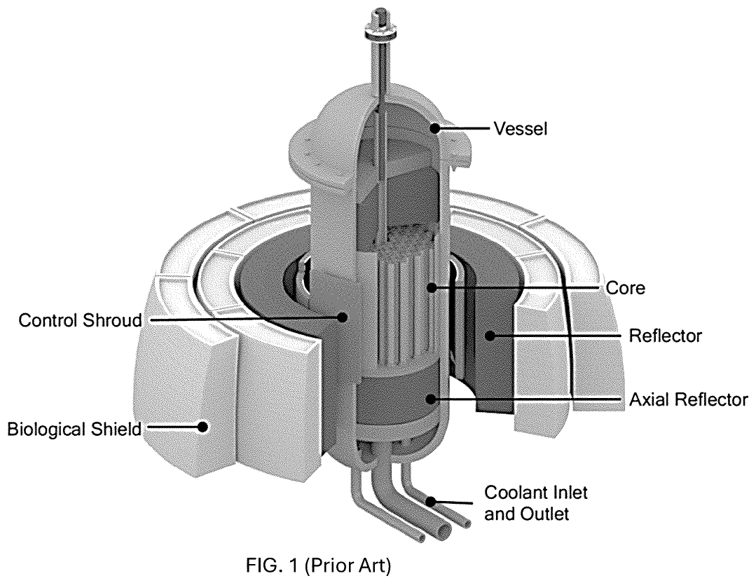

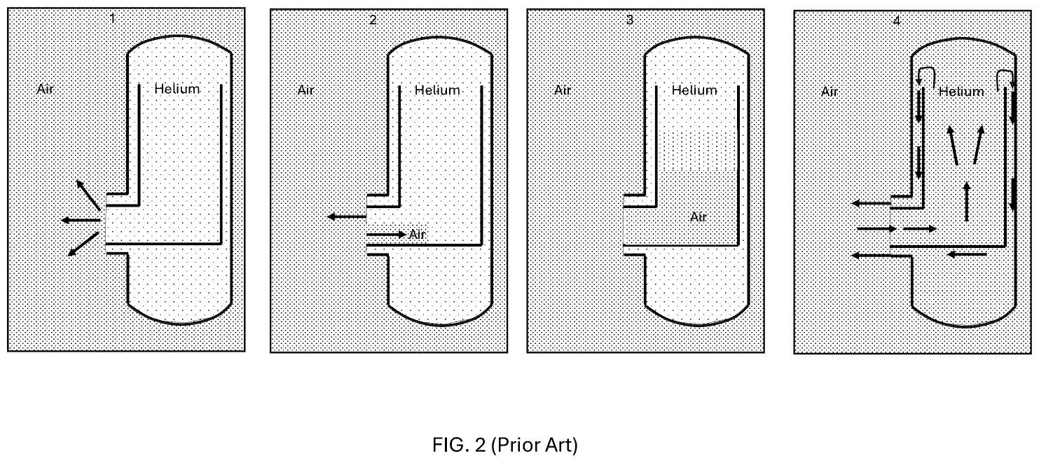

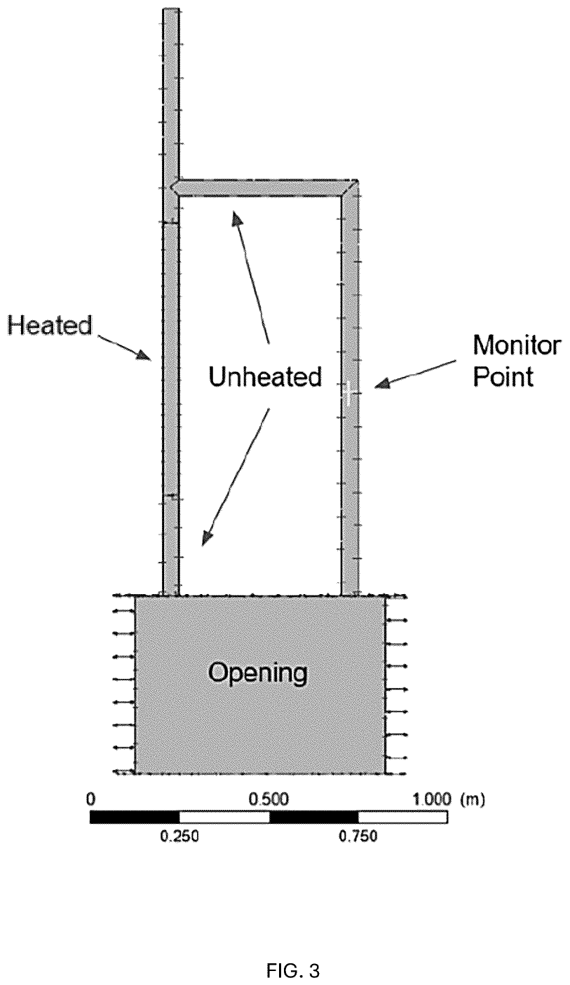

A previous simulation environment was carried out by Gould et al. (D. GOULD, D. FRANKEN, H. BINDRA, and M. KAWAJI, “Transition from molecular diffusion to natural circulation mode air-ingress in high temperature helium loop,” Annals of Nuclear Energy, 107, 103-109 (2017)). Gould's experiment and simulation were designed to investigate how air ingress from the lower plenum or reactor cavity into the core of a high-temperature gas-cooled reactors (HTGR) would occur after a double guillotine break of the main inlet and outlets (depicted in FIGS. 1 and 2). This experimental system was designed in the shape of a lowercase “h” with heaters on the long leg to simulate decay heat in the core as shown in FIG. 3, which is a schematic of domain geometry for simulation showing the monitoring point to help understand ONC during a failure mode of the reactor. The upper leg of the h simulates the upper plenum of the reactor. The analogous simulation system includes connected cylindrical tubes and a larger cylindrical volume at the base simulating room conditions at the outlets.

These simulations found that the simulated predictions of ONC time varied from the experimental data by only 4%, with especially good agreement between heated leg temperatures of 560-760° C. The simulation according to the present disclosure is carried out with the same boundary conditions as Gould's previous work at 760° C. to maintain high fidelity between the simulation conditions.

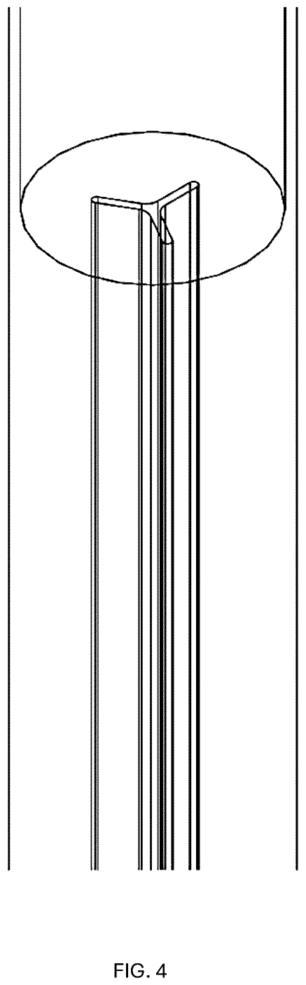

The present disclosure is based on “Y” shaped channels in the fuel and reflector regions of the reactor core, according to one embodiment. An isolated example of one of these channels can be seen in FIG. 4, which is a partial perspective view of an isolated Y-channel, according to the present disclosure. Due to the small gaps in the channel, it is extremely difficult and resource intensive to resolve 3-dimensional computational fluid dynamics analysis in these channels for transient system calculations. Wang et al. (C. WANG, Y. LIU, X. SUN, and P. SABHARWALL, “A hybrid porous model for full reactor core scale CFD investigation of a prismatic HTGR,” Annals of Nuclear Energy, 151, 107916 (2021)) found that simulations which approximated coolant channels in helium cooled HTGRs as porous media were accurate. Wang noted that porous media assumptions can lead to unphysical flows when studying natural convection. To avoid this issue, the diffusion coefficient was modified directly to simulate porosity while a non-porous simulation was run. This change leads to a conservative estimate of ONC time as unmodeled porous effects may further delay ONC time. The present disclosure provides evaluation of ONC time and pressure drop across the system at various porosities to put a constraint on the solid to fluid mass fraction for generic HTGR designs including pebble bed modular reactors.

Given the simplifying assumption that the “Y” channel geometry is replaced with a cylindrical porous media, the system is symmetrical across the plane in which the “h” shape lies. This symmetry allows the use of a symmetry boundary condition, cutting computation time in half. The system is divided into 3 domains. The heated region, a portion of the long leg of the h shape as shown in FIG. 3, has a boundary condition of a constant 760° C., for simulating decay heat. The rest of the cylindrical geometry, the unheated region, has a boundary condition simulating convective and radiative heat loss to the room which is approximated as having a heat transfer coefficient of h=1 W/m²K and an external temperature of 20° C. The open section models a part of the laboratory room environment with an open boundary condition of 100% air at 20° C. which represents room conditions. The open section reduces spurious results generated near the ends of the legs by ensuring entry effects are fully considered.

Previous simulations started with the h-shaped setup that was sealed off from the room and primed with helium gas. The heater was then turned on and allowed to run until the desired steady state temperature was reached in the heated section. This initial condition was simulated by performing an initial simulation with a sealed boundary condition between the unheated sections and the open section. This simulation ended when conditions in the h-tube reached a steady state. These results were then used as initial conditions for another simulation, this time with an open boundary condition between the unheated sections and the open section.

The energy transport and helium-air concentration fields are computed using the multiphysics coupling of the Navier-Stokes equations (partial differential equations that describe flow of fluids) with the energy equation and the scalar transport equation, respectively which are solved using ANSYS CFX commercial code. These equations are provided below. The second order backward Euler numerical scheme and a multigrid accelerated incomplete lower upper factorization technique were used to solve and manipulate the equations to run the simulation. Each simulation was started with an initial time step of 0.001 s, with a maximum allowed value of 0.1 s. Time step length was varied based on rate of convergence.

The continuity equations are provided in D. FRANKEN, D. GOULD, P. K. JAIN, and H. BINDRA, “Numerical study of air ingress transition to natural circulation in a high temperature helium loop,” Annals of Nuclear Energy, 111, 371-378 (2018), and reproduced below.

$$\frac{\partial ρ}{\partial t} + ∇ \cdot ( ρ U ) = 0 ,$$

$$\frac{\partial ( ρ U )}{\partial f} + ∇ \cdot ( ρ U ⊗ U ) = - ∇ p + ∇ \cdot τ ,$$

$$where τ = stress tensor = ( ∇ U + {( ∇ U )}^{T} - \frac{2}{3} δ ∇ \cdot U ;$$

ρ is density (mass/volume);
∇ represents gradient (or divergence) such that,

$$e . g . , ∇ U = \frac{\partial u}{\partial x} + \frac{\partial v}{\partial y} + \frac{\partial w}{\partial z} ,$$

where vector U=(u, v, w);
U is flow velocity (a vector), where U⊗U is a dyad which is a type of tensor product, and where gradient of U⊗U (i.e., ∇·(ρU⊗U) is another vector;
p represents pressure; and
t is time.

The energy equation is expressed as:

$$\frac{\partial ( ρ {h}_{t o t} )}{\partial t} - \frac{\partial p}{\partial t} + ∇ \cdot ( ρ {Uh}_{tot} ) = ∇ \cdot ( k ∇ T ) + ∇ \cdot ( U \cdot τ )$$

where ∇·(U·τ) represents work due to viscous stresses.

The scalar transport (i.e., convention-diffusion) equation is

$$\frac{\partial ( C )}{\partial t} + ∇ \cdot ( UC ) = ∇ \cdot ( {D}_{A B} ∇ C )$$

$$where {D}_{A B} = 1.8583 \times 1 {0}^{- 7} \frac{\sqrt{{T}^{3} ( \frac{1}{{M}_{A}} + \frac{1}{{M}_{B}} )}}{p {σ}_{A B {Ω}_{D}}^{2}} ( {m}^{2} / S ) ,$$

where Ω is a control volume.

To simulate the heated and unheated domain being filled with porous media, the diffusion coefficient of air into helium was modified.

$${( {D}_{A B} )}_{e f f} = \frac{ϵ {D}_{A B}}{q}$$

where ϵ is porosity, and
q is tortuosity, where Tortuosity is assumed to be 1 as would be the case in a narrow channel.

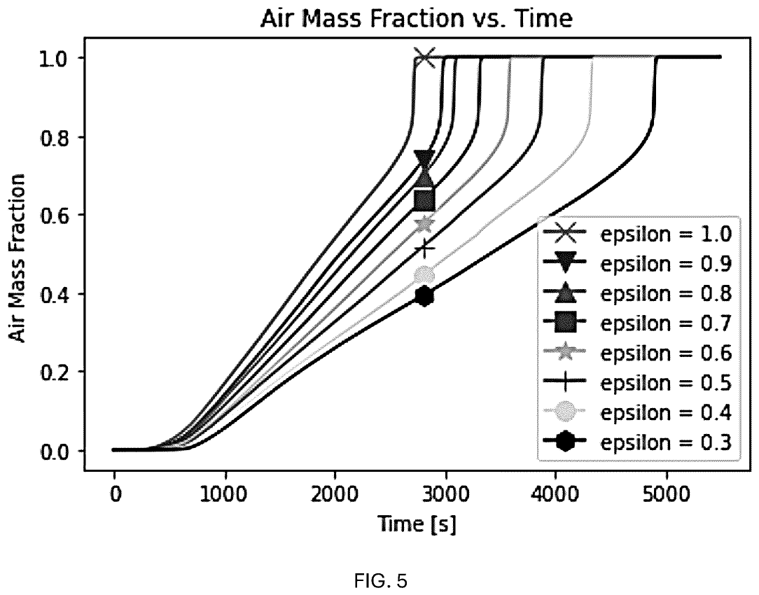

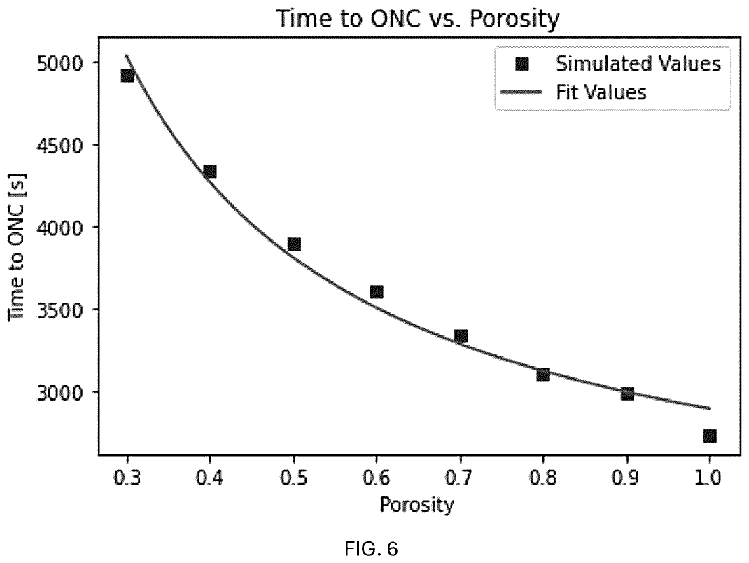

Simulations were conducted for values of e ranging from 0.3-1.0 in increments of 0.1. A monitor point was placed in the middle of the cold leg to track the air mass fraction of the helium air mixture. At the onset of ONC, the mass fraction at this point increases rapidly as the remainder of the helium is forced out of the system and air begins to circulate. This phenomenon can be observed in FIG. 5, which is a graph of air mass fraction over time for different porosities, where the air mass fraction suddenly jumps to 1.0 after a long, steady increase. The time to ONC, defined as the time when the air mass fraction first exceeds 99%, for each ϵ, was extracted from this data and plotted against e in FIG. 6, which is a graph of time to ONC vs. porosity for different levels of porosity provided in FIG. 5. The data plotted in FIG. 6 shows that time to ONC is inversely proportional to E.

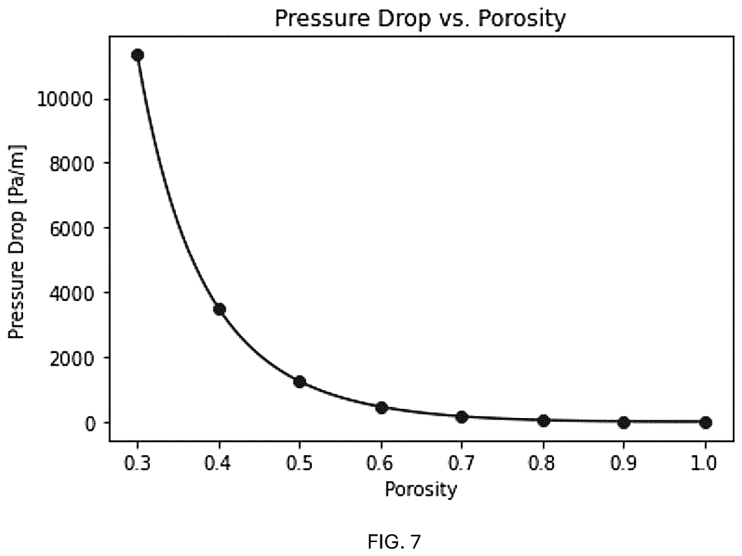

The Kozeny-Carman equation, provided below, relates the pressure drop through porous media to its porosity:

$$\frac{Δ p}{L} = - \frac{1 \; 80 μ {u}_{s}}{{Φ}_{s}^{2} {D}_{p}^{2}} \frac{{( 1 - ∈ )}^{2}}{{∈}^{3}}$$

where μ is the viscosity of He at the expected core temperature,
uₛ is the superficial velocity of He through the core (i.e., porosity multiplied by average velocity of He),
Φs is the sphericity of the particles in the packed bed, A sphericity of 1 has been assumed, corresponding to the shape of a perfect sphere. Dp is the diameter of the particles forming the porous structure, assumed to be 1 cm. Knudsen diffusion can be ignored as the gaps between particles (1-10 mm) are much larger than the mean free paths of the gasses involved (50-500 μm). The relationship between e and pressure drop is shown in FIG. 7, which is a graph of pressure drop vs. porosity. The points on the curve correspond to values of porosity simulated according to the present disclosure. Pressure drop is directly proportional to compressor power consumption, wherein the compressor is used to pressurize the He gas. Therefore the tradeoff between porosity and back work ratio is reflected in the data.

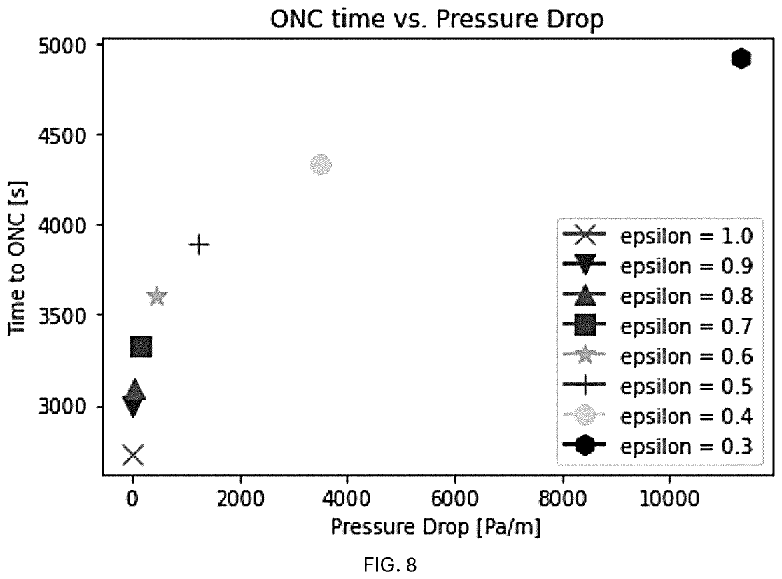

Referring to FIG. 8, which is a graph of ONC time vs. pressure drop for various porosities, which shows that there is diminishing return in ONC time as porosity is decreased. Thus, while decreasing porosity in coolant channels delays ONC, decreasing porosity also increases compressor power consumption at a faster rate, leading to diminishing returns as porosity is decreased.

Consequently, by removing the constraints imposed by conventional manufacturing techniques, advanced manufacturing makes it possible to design and develop more complex core designs with a variety of materials while ensuring rapid production. These methods also allow for incorporation of alternative materials, embedded sensors, and optimal topology. In the space of Nuclear Reactors for power production such methods have allowed the development of innovative core designs which can allow enhanced safety features while achieving better operational performance during normal conditions. In particularly, for gas-cooled reactors which are designed with Helium as a coolant—the main safety challenge is to ensure that air ingress is not allowed within the reactor core under depressurized or off-normal conditions and that can be achieved by flow resistance but higher flow resistance in the core increases pressure drop during normal operation. In other words, the present disclosure optimizes a nuclear reactor core design where safety and economic constraints are considered in the form of flow resistance and it becomes critically important for the case of compressible fluids such as Air or Helium or other gaseous coolants to consider these constraints as a critical design parameter. In the present disclosure, we have obtained an optimal core solid fraction to achieve these objectives. We also show with the help of our experiments that such design can be achieved using additive manufacturing.

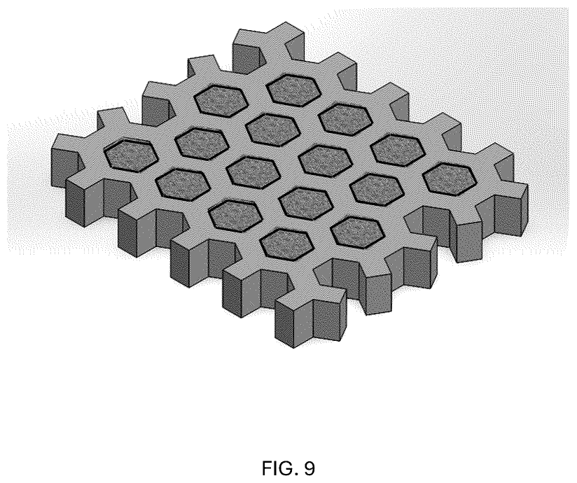

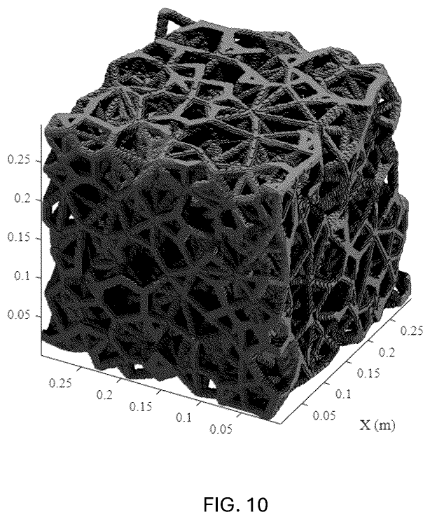

The HTGR according to the present disclosure thus is a honeycomb repeating assembly of solid structures and porous structures. An example of such an assembly is shown in FIG. 9, which is a schematic of an example assembly, where the assembly is shown to include a plurality of hexagonal structures surrounded by solid structures. A perspective view of the porous material is shown in FIG. 10. Within the assembly a plurality of nuclear fuel kernels encapsulated by one or both i) the solid structures; and ii) the porous structures, wherein the solid structures and the porous structures form said heterogeneous honeycomb repeating assembly. In the assembly shown in FIG. 9, the assembly acts as both a moderator and a coolant gas channel. The coolant gas enters from a first end of the assembly and exits out of a second end of the assembly. The assembly represents a ratio of an in-channel porosity to in-channel tortuosity of the assembly of between about 0.2 to about 0.5, wherein the in-channel tortuosity is between about 1.0 representing an open channel and 1.6, and wherein total solid fraction of the assembly is between about 0.6 to about 0.85, wherein the in-channel porosity is defined as the ratio between volume of voids in the channel to total volume of the channel including both voids and solid structures inside the channel, in-channel tortuosity is defined as average path length through channel media divided by total channel length and having a value between 1.0 and 1.6, and total solid fraction is defined as total volume of solid structures in the assembly divided by total volume of the assembly. The assembly can be of different overall shapes, e.g., cylindrically shaped, while the channel can be of various tileable shapes, e.g., hexagonal-shaped, Y-shaped, circular-shaped, octagonal-shaped, triangular-shaped, or other tileable shapes. In the assembly, the solid structures are made of one or more of graphite, yttrium hydride, silicon carbide, or ceramic/metallic nuclear fuel. In the assembly, the porous structures are made of one or more of silicon carbide, graphite, yttrium hydride, or ceramic/metallic nuclear fuel. For systems at the scale of proposed HTGR designs, we find that reducing tortuosity from 1.5 to 1.0 reduces pressure drop by a factor of 4.5. The assembly results in an ONC delay of about 2-5 times the open channel baseline depending upon the ratio of porosity to tortuosity.

While various methods of making encapsulated nuclear fuel kernel and energy systems are known, the following references are incorporated by reference into the present disclosure: U.S. Pat. No. 9,299,464 to Venneri et al., U.S. Pat. No. 10,032,528 to Venneri, U.S. Pat. No. 10,109,378 to Snead, U.S. Pat. No. 10,229,757 to Filippone et al., U.S. Pat. No. 9,620,248 to Venneri, U.S. Pat. No. 10,475,543 to Venneri, U.S. Pat. No. 10,573,416 to 10,573,416, US Pat. Pub. No. 2020/0027587 for Venneri, US Pat. Pub. No. 2017/0287575 for Venneri, US Pat. Pub. No. 2017/0287577 for Venneri, and U.S. Pat. No. 10,643,754 to Venneri et al.

Those having ordinary skill in the art will recognize that numerous modifications can be made to the specific implementations described above. The implementations should not be limited to the particular limitations described. Other implementations may be possible.

1. A high-temperature gas-cooled reactor (HTGR) core, comprising:
a plurality of nuclear fuel kernels encapsulated by i) solid structures; and ii) porous structures, wherein the solid structures and the porous structures form a heterogeneous tileable repeating assembly including a channel for moving heat out of the HTGR core, the assembly is both a moderator and a gas coolant channel, wherein a ratio of in-channel porosity of the assembly to in-channel tortuosity of the assembly is between about 0.2 to about 0.5, wherein the in-channel tortuosity is between about 1.0 representing an open channel and 1.6, and wherein total solid fraction of the assembly is between about 0.6 to about 0.85, wherein the in-channel porosity is defined as the ratio between volume of voids in the channel to total volume of the channel including both voids and solid structures inside the channel, in-channel tortuosity is defined as average path length through channel media divided by total channel length, and total solid fraction is defined as total volume of solid structures in the assembly divided by total volume of the assembly.

2. The HTGR core of claim 1, wherein the assembly is cylindrically shaped.

3. The HTGR core of claim 1, wherein the solid structures are made of one or more of graphite, yttrium hydride, silicon carbide, or ceramic/metallic nuclear fuel.

4. The HTGR core of claim 1, wherein the porous structures are made of one or more of graphite, yttrium hydride, silicon carbide, or ceramic/metallic nuclear fuel.

5. The HTGR core of claim 1, wherein the tileable repeating assembly includes one or more of hexagonal-shaped, Y-shaped, cylindrical-shaped, or triangular-shaped porous-tortuous structures.

6. The HTGR core of claim 1, wherein for tortuosity ranging from about 1.5 to about 1.0 reduces pressure drop by a factor of about 4.5.

7. The HTGR core of claim 1, wherein the assembly results in an ONC delay of about 2 to about 5 times an open channel baseline.
